(19) United States
(12) Patent Application Publication
(10) Pub. No.: US 2020/0328661 A1
(43) Pub. Date: Oct. 15, 2020

(54) METHOD FOR PRODUCING A SEMI-FINISHED PRODUCT OF A STATOR, AND DEVICE FOR PRODUCING A SEMI-FINISHED PRODUCT OF A STATOR

(71) Applicant: Miba Automation Systems Ges.m.b.H., Laarkirchen (AT)

(72) Inventors: Andreas Falkner, Wels (AT); Mladen-Mateo Primorac, St. Pölten (AT); David Scherrer, Gmunden (AT)

(21) Appl. No.: 16/767,798

(22) PCT Filed: Nov. 27, 2018
(86) PCT No.: PCT/AT2018/060278

§ 371 Date: May 28, 2020

(30) Foreign Application Priority Data
Nov. 28, 2017 (AT) A50985/2017

(51) Int. Cl. H02K 15/00; B21D 39/04

(52) U.S. Cl. CPC H02K 15/0087; B21D 39/04

(57) ABSTRACT

The invention relates to a method for producing a semi-finished product of a stator (1), wherein the method comprises the following method steps:
providing a laminated core (2), wherein the laminated core (2) has a plurality of receiving grooves (5) distributed in a circumferential direction;
providing a plurality of conductor elements (3, 4);
inserting the conductor elements (3, 4) into at least some of the receiving grooves (5), wherein the conductor elements (3, 4) are inserted into the receiving grooves (5) in such a way that conductor element overhangs (11, 12) of the conductor elements (3, 4) protrude beyond at least one of the axial end faces (7, 8) of the laminated core (2) in the axial direction;
bending the conductor element overhangs (11, 12) in the radial direction (22);
bending the conductor element overhangs (11, 12) of the conductor elements (3, 4) in the circumferential direction (16, 17).

The invention relates to a method for producing a semi-finished product of a stator or rotor of an electrical machine, as well as a device for carrying out the method.

DE 10 2015 217 922 A1 discloses a method for producing a stator, wherein one electrical conductor element per layer of a two-layer winding is arranged in grooves of a laminated core. For this purpose, it is provided for that at an end face of the laminated core in one or both of the layers, in a positioning process by axially plugging together a normal helix tool with axial conductor ends of some of the conductor elements and subsequent relative rotation of the normal helix tool with respect to the laminated core, and by axially plugging together a selective helix tool with axial conductor ends of the remaining conductor elements, the conductor ends of all conductor elements of the layer are moved relative to each other in such a way that they have a relative end position to each other provided for interconnection of a part of the conductor ends with corresponding conductor ends of the other layer.

The method of DE 10 2015 217 922 A1 has the disadvantage that the conductor ends of the individual layers of conductor elements rub against each other when twisted, which can damage the insulation of the conductor elements.

It was the object of the present invention to overcome the disadvantages of the prior art and to provide a method and a device by means of which a stator can be produced without damaging the conductor elements in the course of this.

This object is achieved by means of a method and a device according to the claims.

According to the invention, a method for producing a semi-finished product of a stator or rotor of an electrical machine is provided. The method comprises the following method steps:

providing an essentially hollow-cylindrical or cylindrical laminated core, wherein the laminated core has a plurality of receiving grooves distributed in a circumferential direction and extending between a first axial end face and a second axial end face of the laminated core;

providing a plurality of rod-shaped or clasp-shaped conductor elements;

inserting the conductor elements into at least some of the receiving grooves, wherein the conductor elements are arranged in receiving grooves spaced apart from one another in different radial conductor element layers and wherein the conductor elements are inserted into the receiving grooves in such a way that conductor element overhangs of the conductor elements protrude beyond at least one of the axial end faces of the laminated core in the axial direction, wherein the conductor element overhangs extend from a laminated core end face region to an end region via a central region;

bending the conductor element overhangs in the radial direction;

bending the conductor element overhangs of the conductor elements in the circumferential direction, wherein the conductor element overhangs of conductor elements of a first radial conductor element layer are bent into a first circumferential direction and conductor element overhangs of conductor elements of a second radial conductor element layer are bent into the opposite second circumferential direction, such that the end regions of conductor elements that are arranged in receiving grooves spaced apart from one another and are located in conductor element layers adjacent to one another are joined.

The method according to the invention has the advantage that by bending the conductor element overhangs in the radial direction, the friction of the conductor elements against one another during subsequent bending of the conductor element overhangs in the circumferential direction can be reduced. Thereby, it can be achieved that during bending of the conductor element overhangs in the circumferential direction, the insulation layer is not scraped off. This entails the advantage that the quality of the stator can be improved.

It can moreover be useful if the conductor element overhangs are bent in a bulbous manner in the radial direction, wherein the conductor element overhangs are bent such that at the end of the bending process the end region of the conductor element overhangs is closer to the center of the laminated core than the central region of the conductor element overhangs. In other words, the conductor element overhangs are bent such that they have a bulbous curvature towards the outside. By this measure, the shape of the conductor element overhangs can be adapted to the end shape of the conductor element overhangs after bending in the circumferential direction, whereby shearing of the conductor element overhangs can be reduced.

Furthermore, it can be provided for that the central region of the conductor elements is bent radially outwards. Thereby, a particularly favorable shape for preventing shearing of the insulation layer can be achieved.

In addition to this, it can be provided for that during bending of the conductor element overhangs in the radial direction, an—as radially seen—inner bending tool presses radially outwards against the central region of the conductor element overhang and an—as radially seen—outer bending tool presses radially inwards at least against the end region of the conductor element. The advantage of this is that by means of the inner bending tool and the outer bending tool, bending of the conductor element overhangs in the radial direction can be achieved.

A design according to which it can be provided for that the inner bending tool and the outer bending tool are designed as rolling tools, which are guided around the circumference of the laminated core at least once in a rolling operation, is also advantageous. Such a rolling tool entails the advantage that all conductor element overhangs can be bent uniformly. Such a rolling tool can, moreover, have a simple structure and thus be produced cost-effectively.

According to a further embodiment, it is possible that the bending tools are guided around the circumference of the laminated core several times, wherein the feed operation of the inner bending tool and/or of the outer bending tool takes place distributed over several revolutions. By this measure, bending can be carried out in several individual steps, such that the conductor element overhangs do not have to be bent excessively per bending step.

In the alternative to this, it can be provided for that the inner bending tool and the outer bending tool are formed as a pressing tool segmented in the circumferential direction, which are displaced in the radial direction. In this regard, the individual segments of the bending tool can be formed to be uniformly distributed across the circumference. Such a segmented pressing tool has the advantage that the entire bending operation of the conductor element overhangs can be carried out in a single working step and thus the processing time is reduced.

In yet another embodiment variant, it can also be provided for that just one single pair of outer bending tool and inner bending tool is designed as a segmented pressing tool, which extends across a partial section of the circumference. The laminated core with the conductor elements accommodated therein can thus be bent sequentially. By stepwise rotation of the laminated core and repeated bending, all conductor elements distributed across the circumference can be bent.

Moreover, it can be provided for that the inner bending tool comprises a camber. By means of the camber, the bulbous deformation of the conductor element overhangs can be achieved.

Moreover, it can be provided for that the outer bending tool comprises a depression corresponding to the camber. By this measure, clean bending of the conductor element overhangs can be achieved.

It is particularly advantageous if the bulbous deformation of the conductor element overhangs comprises a uniform transition radius.

According to a particular embodiment, it is possible that several conductor elements, which are arranged in one receiving groove, of different radial conductor element layers are jointly bent in the radial direction, wherein the—as radially seen—inner bending tool presses against the conductor element overhang of the conductor element arranged in the innermost radial conductor element layer and the—as radially seen—outer bending tool presses against the conductor element overhang of the conductor element arranged in the outermost radial conductor element layer. By this measure, several conductor elements, which are arranged in different conductor element layers, accommodated in one receiving groove can be bent simultaneously.

According to an advantageous further embodiment, it can be provided for that the conductor element overhangs are bent such in the radial direction that they rub against one another as little as possible during bending of the conductor element overhangs in the circumferential direction. By this measure, it can be achieved that the insulation layer is as far as possible not damaged during bending in the circumferential direction.

In particular, it can be advantageous if the conductor element overhangs are bent in a bulbous manner in the radial direction such that the conductor element overhangs after the bending operation have a radius essentially corresponding to the radius of the respective conductor element layer in which they are arranged. By this measure, shearing of the insulation layer can be prevented surprisingly well.

Moreover, it can be provided for that during bending of the conductor element overhangs in the radial direction, spacers are arranged between the individual conductor elements of different radial conductor element layers. By this measure, it can be achieved that after the bending operation of the conductor element overhangs in the radial direction, the individual conductor elements, which are arranged in a receiving groove, are spaced apart slightly, whereby the further bending operation of the conductor element overhangs in the circumferential direction is facilitated.

Moreover, it can be provided for that the conductor elements are positioned such in the laminated core, that on both axial end faces of the laminated core conductor element overhangs are formed and that the conductor element overhangs on both axial end faces of the laminated core are bent in the radial direction.

An embodiment, according to which it can be provided for that the conductor elements are arranged in at least six different conductor element layers, is also advantageous. A thus structured stator is suitable for the application of large torques.

According to a further embodiment, it is possible that in at least some of the receiving grooves, one conductor element is arranged in each conductor element layer.

Moreover, it can be provided for that the individual conductor elements or groups of conductor elements are fanned out and thus spaced apart from one another after bending in the radial direction. Thereby, subsequent bending of the conductor elements in the circumferential direction can be facilitated.

It can further be provided for that bending of the conductor elements in the circumferential direction and fanning out of the conductor elements are carried out in one setting. In this way the setup time and/or nonproductive time can be kept as short as possible. In particular, it is conceivable that in a machine, the inner bending tool is arranged for radial bending of the conductor elements and the inner fanning tool is arranged for fanning out.

It can further be useful if the conductor elements are inserted into the laminated core such that the conductor element overhangs of the conductor elements of the first radial conductor element layer have a lower extension than conductor element overhangs of the conductor elements of the second radial conductor element layer, wherein a graduation is formed by the conductor elements, wherein, during fanning out, an inner fanning tool engages on an offset of the graduation and is pressed against the outer conductor element, thereby pressing it outwards. Thus, fanning out can be facilitated since the offset can serve as a stop.

Moreover, it can be provided for that the conductor element overhangs of the conductor elements, after fanning out, are brought into their end position by means of an end positioning tool acting in the axial direction of the main axis. During end positioning, the conductor element overhangs can be brought into their exact position for subsequent bending in the circumferential direction.

Moreover, it can be provided for that after bending in the circumferential direction, the conductor element overhangs of the conductor elements are bent together in pairs in the radial direction.

According to the invention, a device for producing a semi-finished product of a stator or rotor of an electrical machine is provided. The device comprises a receiving device for receiving a hollow-cylindrical or cylindrical laminated core having conductor elements which are arranged in receiving grooves of the laminated core and which comprise conductor element overhangs. Moreover, an—as radially seen—inner bending tool and an—as radially seen—outer bending tool are formed, wherein the bending tools are formed for bending the conductor element overhangs in the radial direction.

In addition to this, it can be provided for that the inner bending tool and the outer bending tool are formed as a rolling tool.

In the alternative to this, it can be provided for that the inner bending tool and the outer bending tool are formed as a pressing tool segmented in the circumferential direction, which are displaceable in the radial direction.

If two conductor elements are accommodated in a receiving groove, the conductor element located on the inner side is referred to as inner conductor element and the conductor element located on the outer side is referred to as outer conductor element.

It can further be provided for that the conductor element overhangs of the conductor elements are uniformly bent in the radial direction via their longitudinal extensions.

Moreover, it can be provided for that the inner bending tool and/or the outer bending tool comprises an elastic coating on the contact surface. By this measure, the conductor elements can be protected from excessive mechanical load. In particular, it can thereby be prevented that an insulation layer arranged on the conductor elements is damaged by the bending tools.

If several conductor elements, for example 4, 6, 8 or 10 conductor elements, are accommodated in a receiving groove, in each conductor element pair the conductor element located on the inner side is referred to as inner conductor element and the conductor element located on the outer side is referred to as outer conductor element. Since the conductor elements are preferably accommodated in the receiving groove pair-wise and there is thus an even number of conductor element layers, the conductor element located closest to the center is referred to as inner conductor element and the conductor element located outermost is referred to as outer conductor element.

It can further be provided for that the conductor element overhangs are bent on a length of between 50% and 100% of the total length of the conductor element overhangs.

Since the designations first conductor element overhang and second conductor element overhang refer to the side of the laminated core, the outer conductor element can comprise a first conductor element overhang and a second conductor element overhang.

For the purpose of better understanding of the invention, it will be elucidated in more detail by means of the figures below.

These show in a respectively very simplified schematic representation:

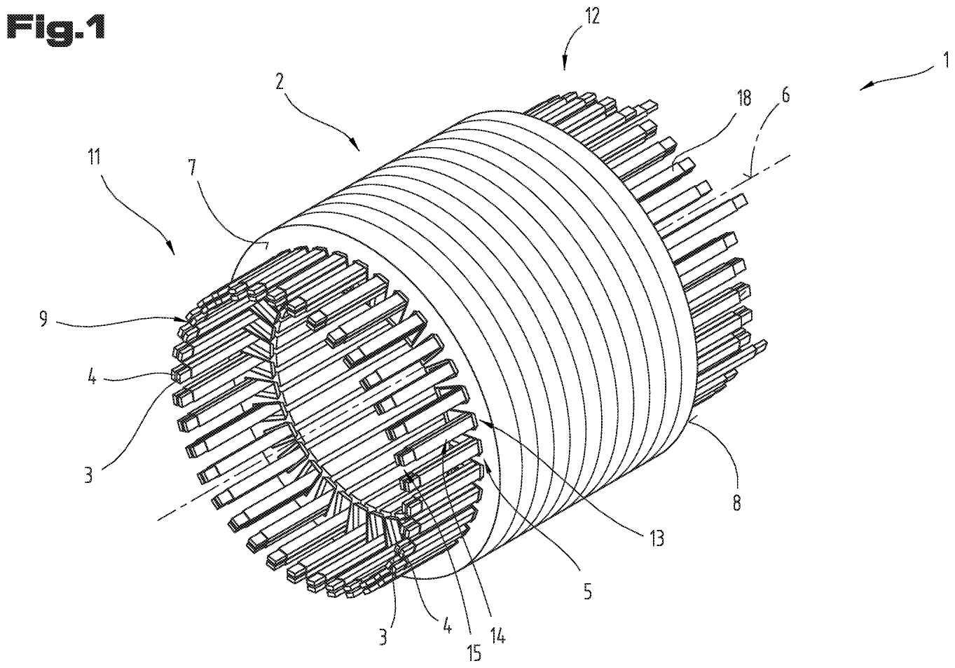

FIG. 1 a schematic representation of a stator;

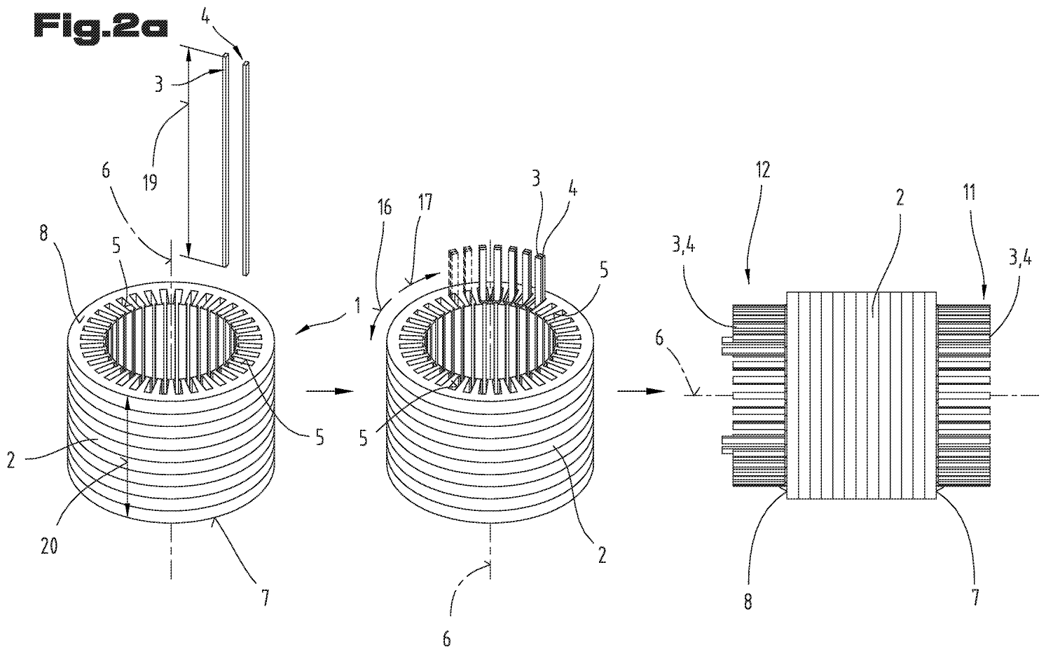

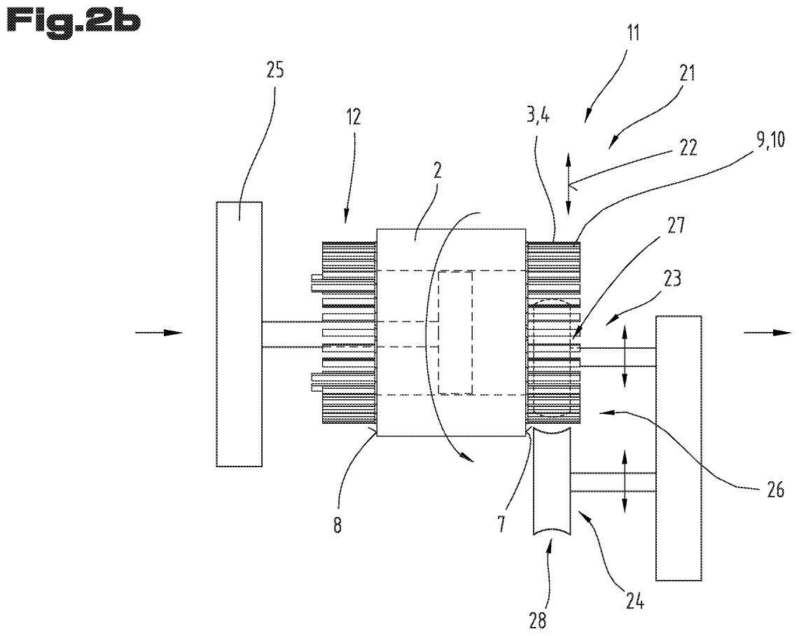

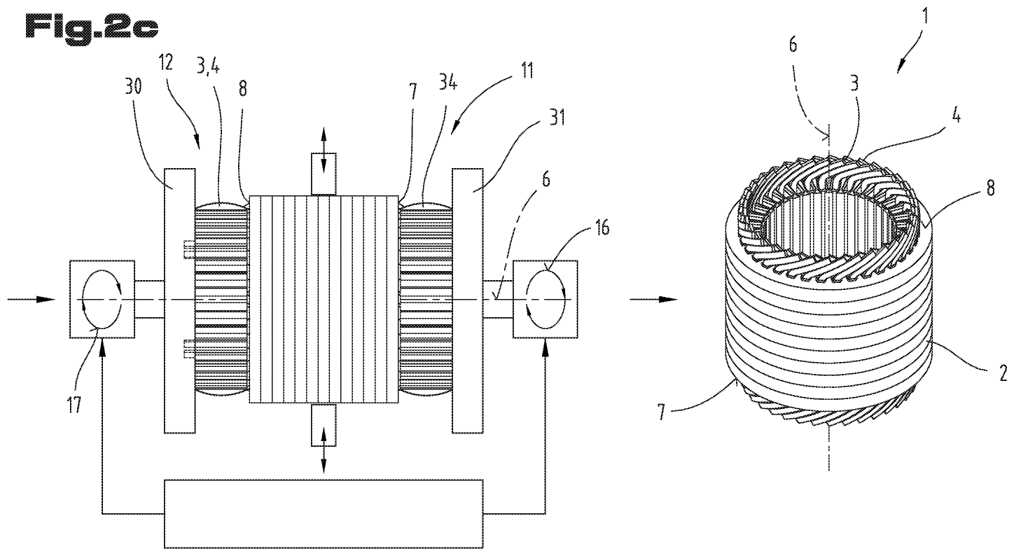

FIG. 2 a method sequence for the production of a stator;

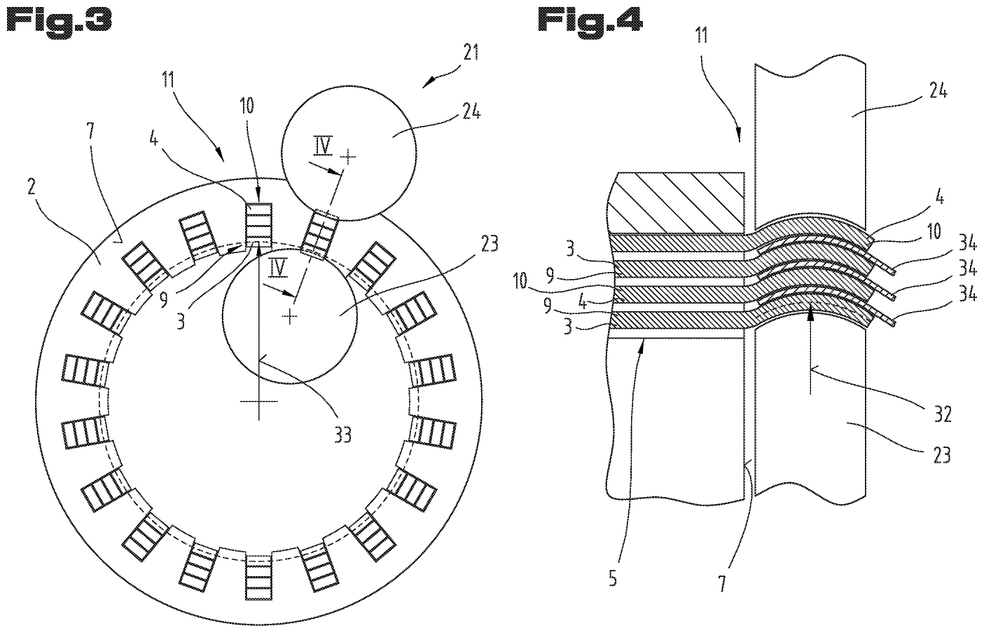

FIG. 3 a front view of a laminated core of a stator with the conductor elements accommodated therein and rollers for bending the conductor element overhangs;

FIG. 4 a sectional view of a stator according to section line IV-IV of FIG. 3;

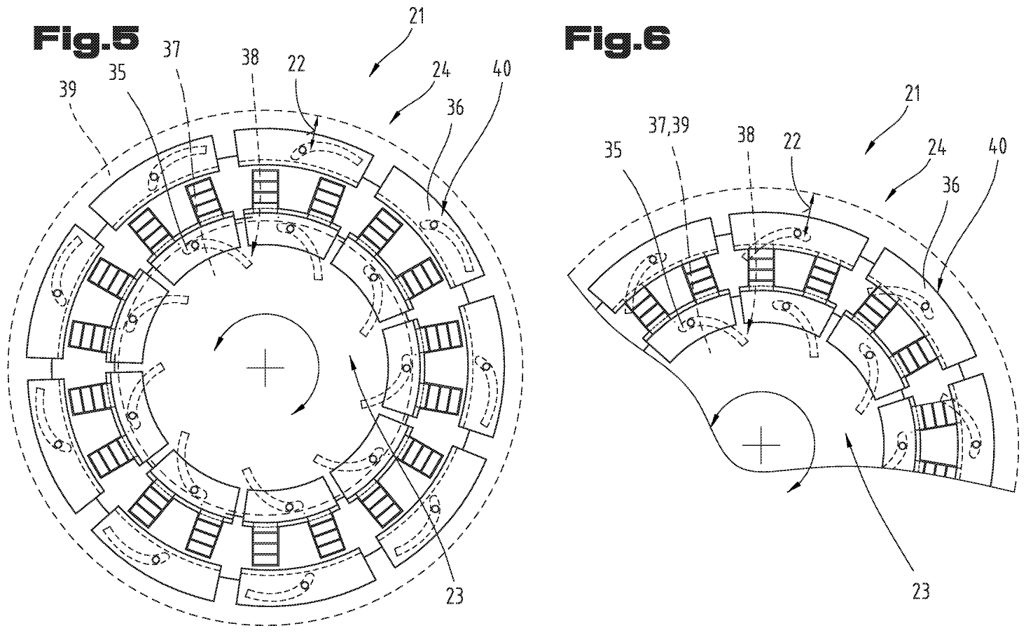

FIG. 5 a front view of a laminated core of a stator with the conductor elements accommodated therein and a segmented bending tool for bending the conductor element overhangs;

FIG. 6 a front view of a laminated core of a stator with the conductor elements accommodated therein and a further exemplary embodiment of a segmented bending tool for bending the conductor element overhangs;

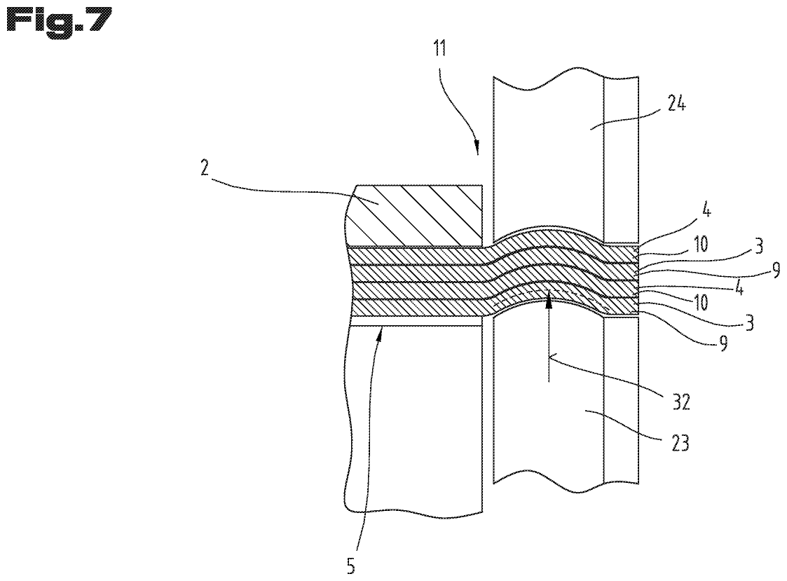

FIG. 7 a sectional view of a further exemplary embodiment of a stator according to section line IV-IV of FIG. 3;

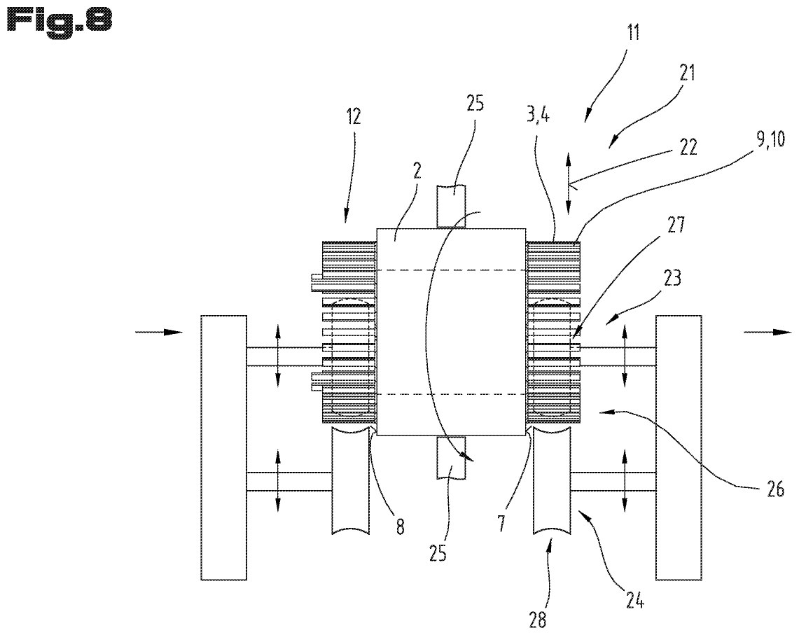

FIG. 8 a device for simultaneous radial bending of the first and the second conductor element overhangs;

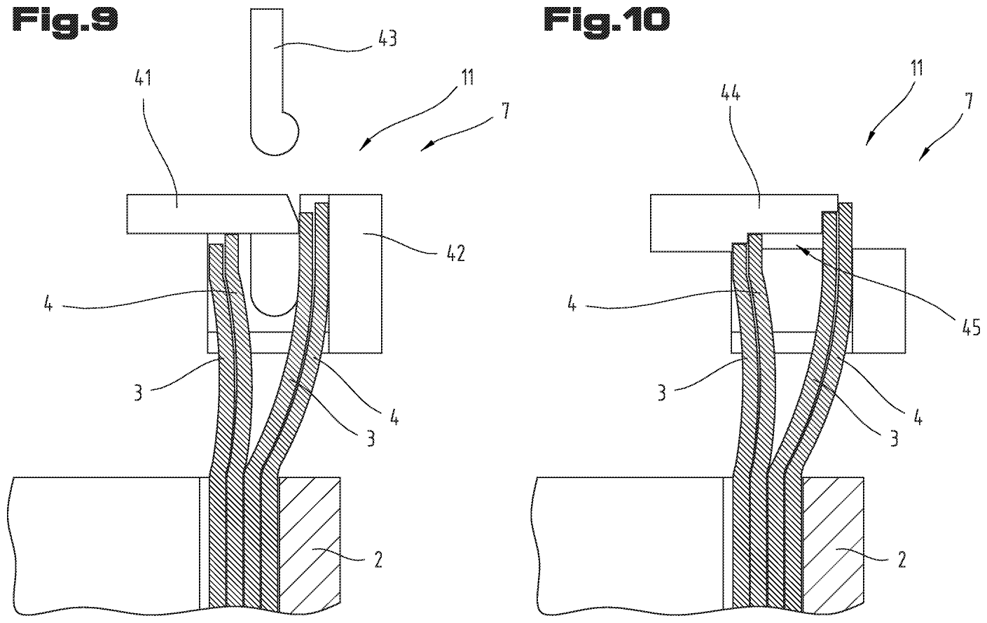

FIG. 9 a schematic representation of the fanning out operation;

FIG. 10 a schematic representation of the longitudinal positioning operation.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a possible formation of a stator 1 for forming an electric machine not depicted in more detail. However, it would also be possible to analogously apply and carry out the description and embodiment below also to a rotor for forming an electric machine. The description below refers only to a stator 1, but it may equally relate to a rotor.

The assembly and a plurality of manufacturing steps of the stator 1 can be carried out in an automated manner, largely even in a fully-automated manner, in several manufacturing stations, preferably in a complex manufacturing plant.

In general, the stator 1 comprises a laminated core 2, as well as a plurality of conductor elements 3, 4 accommodated therein for forming electric coils and/or windings and for generating a rotating magnetic field resulting from the application of current to the coils and/or windings.

In the present exemplary embodiment of FIG. 1, the individual conductor elements 3, 4 are shown in their non-deformed initial situation, in which they are formed as straight rods. The rods typically have a rectangular cross-section up to a square cross-section as well as a longitudinal extent and are formed by an electrically-conductive material. This material is usually a copper material. Thus, these can also be referred to as profile rods and the electric winding built up therewith can be referred to as rod winding.

A plurality of receiving grooves 5 are arranged or configured in the laminated core 2 spread over the circumference for forming electric coils and/or windings formed thereby, in which receiving grooves at least one of the conductor elements 3, 4, but preferably at least two of the conductor elements 3, 4, is or are respectively accommodated or arranged. The receiving grooves 5 can extend in the axial direction of the laminated core 2 in a parallel alignment with respect to a main axis 6 defined by the laminated core 2. However, it would also be possible to select an alignment not parallel with respect to the main axis 6 of the receiving grooves 5 with the conductor elements 3, 4 to be accommodated therein. In any case, the receiving grooves 5 respectively extend in the direction of the main axis 6 between a first end face 7 and the second end face 8 of the laminated core 2 arranged spaced apart therefrom.

The receiving grooves 5 respectively have a cross-section of the receiving groove adapted to the cross-sectional dimension of the conductor element 3, 4 or in case of several conductor elements 3, 4 accommodated in the same receiving groove 5 a cross-section of the receiving groove adapted to the cross-sectional dimensions to same.

The laminated core 2 is bounded in the direction of its main axis 6 by the first front face at its first end face 7 and by the second front face at its second end face 8 arranged to be spaced apart therefrom. Preferably, the two front faces and/or end face 7, 8 are arranged in parallel to one another as well as running in a plane aligned in a normal direction with respect to the main axis 6. In the present exemplary embodiment of the stator 1 of an electrical machine, the laminated core 2 forms a hollow cylinder with an inner surface and an outer surface.

As elucidated above, at least one of the conductor elements 3, 4 is arranged in each receiving groove 5. However, it is also possible that several, in particular two, three, four, five, six or more conductor elements 3, 4 are provided per receiving groove 5. In particular, eight, ten, twelve or more conductor elements 3, 4 can be accommodated in each one of the receiving grooves 5. However, in particular, it is provided for that an inner conductor element 3 and an outer conductor element 4 are present.

The conductor elements 3 arranged in the radial direction on the inside form a first conductor element layer 9 and the conductor elements 4 arranged in the radial direction on the outside form a second conductor element layer 10. Of course, further conductor element layers can be provided according to the statements above. For the purpose of clarity, in the exemplary embodiment according to FIG. 1 merely the conductor elements 3 arranged on the inside and the conductor elements 4 arranged on the outside of a first conductor element pair are shown.

The rod-shaped conductor elements 3 and 4, which in the original state extend straightly, are preferably arranged such in the laminated core 2 that they have a first conductor element overhang 11, which protrudes with respect to the first end face 7 of the laminated core 2, and have a second conductor element overhang 12, which protrudes with respect to the second end face 8 of the laminated core 2.

The individual conductor element overhangs 11, 12 respectively extend from a laminated core end face region 13, which is located in the region of the end face 7, 8 of the laminated core 2, to an end region 15 via a central region 14. The end region 15 of the conductor element overhang 11, 12 at the same time is the end region 15 of the conductor element 3, 4.

The conductor elements 3, 4 that are accommodated in the individual receiving grooves 5 in the laminated core 2 and are still undeformed in the original state, can be formed by straight rods, which, in a subsequent processing step, are interlocked with one another in the region of the first conductor element overhang 11 and/or the second conductor element overhang 12 and/or are bent in a circumferential direction 16, 17 of the laminated core 2. Then, the end regions 15 of the first or inner conductor element layer 9 selectively are electroconductively connected to corresponding end regions 15 of the second or outer conductor element layer 10. This can be carried out both on the first conductor element overhangs 11 and/or on the second conductor element overhangs 12.

In an alternative variant, it can also be provided for that the conductor elements 3, 4 are provided in the form of hairpins, which are already interlocked with one another at a conductor element overhang 12 and/or have a corresponding bending prior to the insertion into the laminated core 2.

In known manner, the conductor elements 3, 4 can be provided with and/or surrounded by an electrical insulation layer 18 except for the end regions 15. This insulation layer 18 on the lateral surface of the rod-shaped conductor elements 3, 4 is preferably formed from a plastic material and can have been applied in a previous painting and/or dipping process.

When the conductor element overhangs 11, 12 are bent in the circumferential direction 16, 17, it is important that the insulation layer 18 is not scraped off by rubbing of the individual conductor elements 3, 4 from different conductor element layers 9, 10 against one another.

Loading or insertion of the individual conductor elements 3, 4 into the respective receiving grooves 5 can be carried out in steps or in cycles. As the typically still undeformed conductor elements 3, 4 are accommodated so as to be longitudinally displaceable in the respective receiving grooves 5, the relative position of the conductor elements 3, 4 with respect to the laminated core 2 is to be taken into consideration or a predefined relative position of the conductor elements 3, 4 with respect to the laminated core 2 is to be ensured during the transfer to a downstream processing station or manufacturing station.

In a positioning step to be carried out preferably before the transfer or passing on to the downstream processing station or manufacturing station, the conductor elements 3, 4 can still be aligned in an axial direction with respect to one of the end faces 7, 8. This can be done, for example, by moving the laminated core 2 including the conductor elements 3, 4 already accommodated therein from its preferably horizontal feed position to a vertical positioning position, in which the main axis 6 of the laminated core 2 has a vertical longitudinal alignment. The laminated core 2 be supported on a positioning projection, wherein the conductor elements 3, 4 in a preferably gravity-induced manner come into contact within the individual receiving grooves 5 with one of their end regions 15 up to a positioning element preferably formed circumferentially. The distance between the positioning projection and the positioning element is to be selected in accordance with the required and/or predefined overhang of the end regions 15 of the conductor elements 3, 4 beyond one of the end faces 7, 8 of the laminated core 2. This transport position may, for example, be taken on a work carrier movable between individual ones of the workstations.

By means of the method steps listed below, as are also schematically shown in FIGS. 2a to 2c, an automated or at least partially automated production of at least one semi-finished product of the generic stator 1 and/or rotor for electrical machines can be achieved.

In an initial step, an essentially hollow-cylindrical laminated core 2 is provided. This laminated core 2 comprises a plurality of receiving grooves 5 for line sections of an electrical winding to be produced, which are distributed in the circumferential direction and extend between the first axial end face 7 and the second axial end face 8 of the laminated core 2. In the shown embodiment with a fixed stator 1, the laminated core 2 is designed as a hollow-cylindrical body. However, a stator can also be designed with an essentially cylindrical body shape, wherein the corresponding electrical machine and/or the corresponding motor would then be designed as a so-called external rotor motor having a hollow-cylindrical rotor.

Moreover, a plurality of rod-shaped conductor elements 3, 4 are provided, which in the initial and/or original state, in particular in their insertion state with respect to the laminated core 2, have a straight and/or essentially straight shape, in particular a rod shape. These rod-shaped conductor elements 3, 4 can, depending on the extension of the receiving grooves 5, also be helix-like and/or helical in their contour, which is particularly the case with so-called obliquely grooved laminated cores 2 and/or stators 1 or rotors. The rod-shaped conductor elements 3, 4 each have a first longitudinal end 11, 12 and a distally opposite, second longitudinal end 13, 14. This plurality of rod-shaped conductor elements 3, 4 is provided by predefined electrical circuits and/or connections for forming the electrical winding of the stator 1. In this regard, a length 19 of the rod-shaped conductor elements 3, 4 is larger than an axial length 20 of the laminated core 2.

In a method step that is preferably carried out automatically, the rod-shaped conductor elements 3, 4 are inserted in pairs or in groups, in particular in a multiple number of two, into each one of the receiving grooves 5, as can be seen from FIG. 2a. For the sake of simplicity, only individual ones of the conductor elements 3, 4 inserted into the laminated core 2 are shown. The insertion of the unbent, rod-shaped conductor elements 3, 4 into each one of the receiving grooves is preferably carried out starting out from the first or second axial end face 7, 8 of the laminated core 2.

In a subsequent method step, the rod-shaped conductor elements 3, 4 inserted in the receiving grooves 5 are positioned such that their first and second end regions 15 respectively protrude with regard to the first and second end face 7, 8 of the laminated core 2 and thus form a first conductor element overhang 11 and a second conductor element overhang 12. In this regard, individual conductor elements 3, 4 can have a greater length 19 than other conductor elements 3, 4 within the electrical winding to be formed. In this respect, the comparatively longer conductor elements 3, 4 can in particular be provided for forming winding connections and/or connection zones.

In a further method step, which is shown in FIG. 2b, the laminated core 2 with the conductor elements 3, 4 accommodated therein is fed to a device 21, in which the conductor element overhangs 11, 12 are bent in the radial direction 22. For this purpose, an inner bending tool 23, which presses against the inner conductor element 3, and an outer bending tool 24, which presses against the outer conductor element 4, are provided.

Moreover, a receiving device 25 can be provided, which serves for receiving the laminated core 2. The receiving device 25 can in particular be designed as an expanding mandrel, which is guided into the inside of the laminated core 2 and can clamp the laminated core 2.

In the alternative to this, it can be provided for that the receiving device 25 comprises clamping jaws, which clamp the laminated core 2 on its outer circumference.

In the exemplary embodiment according to FIG. 2b, the inner bending tool 23 as well as the outer bending tool 24 are designed as a rolling tool 26, which is designed for bending the conductor element overhangs 11, 12 in the radial direction. In particular, it can be provided for that the inner bending tool 23 comprises a camber 27 and that the outer bending tool 24 comprises a depression 28. The camber 27 and the depression 28 are adapted to one another.

For bending the conductor element overhangs 11, 12 in the radial direction 22, the inner bending tool 23 is fed in the direction towards the inner conductor element 3 and/or the innermost of the inner conductor elements 3 and the outer bending tool 24 is simultaneously fed in the direction towards the outer conductor element 4 and/or the outermost of the outer conductor elements 4. After contact of the inner bending tool 23 with the inner conductor element 3 and the outer bending tool 24 with the outer conductor element 4, the conductor element overhang 11, 12 is bent in a further feed of the bending tools 23, 24. Subsequently, the laminated core 2 can be rotated about its main axis 6 by means of the receiving device 25, such that all conductor elements 3, 4 arranged to be distributed across the circumference are bent in the radial direction 22. In particular, it can be provided for that after termination of one revolution, the inner bending tool 23 and/or the outer bending tool 24 is fed farther, such that the total feed operation is carried out distributed onto several revolutions.

In an alternative embodiment variant, it can also be provided for that the laminated core 2 is held in place by means of the receiving device 25 and that the bending tools 23, 24 designed as rolling tools 26 are guided around the circumference of the laminated core 2. In yet another embodiment variant, it is also conceivable that according to a combination of the two embodiment variants described above, both the laminated core 2 and the bending tools 23, 24 are moved.

As can be seen from FIG. 2b, it can be provided for that in a first step merely the first conductor element overhangs 11 of the conductor elements 3, 4 are bent in the radial direction 22. Subsequently, the stator 1 can be turned around such that the second conductor element overhangs 12 of the conductor elements 3, 4 can be bent in the radial direction 22.

In FIGS. 3 and 4, the device 21 and/or the bending operation in the radial direction 22 is described in more detail.

After bending of the conductor elements 3, 4 in the radial direction 22, as can be seen from FIG. 2c, defined bending and/or cranking of the first and second conductor element overhangs 11, 12 of the rod-shaped conductor elements 3, 4 in the circumferential direction 16, 17 of the laminated core 2 is carried out. In particular, the first conductor element overhangs 11 of the inner conductor elements 3 are bent in a first circumferential direction 16 and the first conductor element overhangs 11 of the outer conductor elements 4 are bent in a second circumferential direction 17. The second conductor element overhangs 12 can be bent in mirror-inverted manner.

According to a useful measure, in the course of this bending and/or deformation process, it is provided for that at least one first turning tool 30 is attached and/or placed on the first conductor element overhangs 11 of the conductor elements 3, 4. Additionally, in particular essentially at the same time or slightly later, at least one second turning tool 31 is attached and/or placed on the second conductor element overhangs 12 of the conductor elements 3, 4. In this regard, the at least one first turning tool 30 and the at least one second turning tool 31 can, in a manner that is known per se, have positively locking receiving pockets for the first conductor element overhangs 11 and/or for the second conductor element overhangs 12. It is thus also possible that the turning tools 30, 31 are primarily based on a frictional engagement principle and/or on another driver principle for controlled plastic deformation of the conductor elements 3, 4.

In particular, it can be provided for that this bending of the first conductor element overhangs 11 and/or the second conductor element overhangs 12 in the circumferential direction 16, 17 is carried out on the same device 21 as the bending of the conductor element overhangs 11, 12 in the radial direction 22.

In this regard, the receiving device 25 can be designed according to any mechanisms known from the prior art. For example, the receiving device 25 can be designed in the form of a pincer gripper, a multiple finger gripper, or even in the form of a magnetic gripper and/or an electromagnetic receiving device.

The at least one first and the at least one second turning tool 30, 31 can be designed to be formed of multiple parts, in particular comprise part tools that are concentrically fitted into one another and independently rotatable. These part tools per turning tool 30, 31 on the axial end faces 7, 8 of the laminated core 2 are rotated in the opposite directions, as is known from the prior art, to bend adjacent conductor element layers 9, 10 of conductor element overhangs 11, 12 in opposite circumferential directions 16, 17. An interlocked deformation of the conductor element overhangs 11, 12 of the conductor elements 3, 4 can be achieved by the opposite rotational movement of several part tools per turning tool 30, 31. In particular, one part tool is provided per conductor element layer 9, 10 and per end face 7, 8 of the laminated core 2, such that in the represented exemplary embodiment, two part tools concentrically fitted into one another define the first turning tool 30 and two part tools concentrically fitted into one another define the second turning tool 31.

After termination of the bending operation in the circumferential direction, the individual end regions 15 of the individual conductor elements 3, 4, which face one another, can be welded together.

FIG. 3 shows the laminated core 2 with the conductor elements 3, 4 in a top view onto the first end face 7.

FIG. 4 shows a sectional view of the laminated core 2 according to section line IV-IV from FIG. 3.

FIGS. 3 and 4 show the deformation operation and/or the device 21 for bending the conductor element overhangs 11, 12 of the conductor elements 3, 4 in the radial direction 22.

As can be seen from a combination of FIGS. 3 and 4, the conductor element overhangs 11, 12 can be bent such that a radius 32 of bending the conductor element 3, 4 is approximately of the same size as a radius 33 of the conductor element layer 9, 10 in which the conductor element 3, 4 is arranged. Thereby, during further bending of the conductor element overhangs 11, 12 in the circumferential direction, shearing of the insulation layer 18 of the conductor elements 3, 4 can be prevented.

As can particularly well be seen from FIG. 4, it can be provided for that only the innermost located inner conductor element 3 and/or the outermost located outer conductor element 4 are touched by the bending tools 23, 24. The conductor elements located in between can be clamped between the inner conductor element 3 and the outer conductor element 4 and be bent by the clamping. Hence, it is possible to simultaneously bend several conductor elements arranged in one receiving groove 5.

As can be seen from FIG. 4, it can be provided for that spacers 34, by means of which the individual conductor elements 3, 4 are spaced apart from one another, are inserted between the conductor element overhangs 11, 12 of the individual conductor elements 3, 4 during the radial bending operation.

After the termination of the bending operation, the spacers 34 can be removed, whereby an air gap is formed between the individual conductor elements 3, 4, by means of which it can be avoided that the individual conductor elements 3, 4 shear against one another during bending in the circumferential direction.

As can be seen from FIG. 7, the spacers 34 can also be omitted such that the conductor element overhangs 11, 12 of the individual conductor elements 3, 4 lie directly against one another.

As can further be seen from FIG. 7, the inner bending tool 23 and the outer bending tool 24 can have a surface parallel to the main axis 6 on their edge region distant from the receiving device 25. In other words, the inner bending tool 23 and the outer bending tool 24 can have a section with a cylindrical surface on its edge region distant from the receiving device 25. Thereby, the conductor element overhangs 11, 12 can be bent in the radial direction 22 such that after termination of the bending operation the end region 15 of the conductor element overhangs 11, 12 is aligned in parallel to the main axis 6. This entails the advantage that the end region 15 of the conductor element overhangs 11, 12 can be well gripped during subsequent bending in the circumferential direction 16, 17. Moreover, by this measure the conductor element overhangs 11, 12 can be exactly positioned with respect to one another in the subsequent welding operation.

Such a formation of the inner bending tool 23 and the outer bending tool 24 can be provided for in all described embodiment variants of bending tools 23, 24.

In the alternative to this, it can also be provided for that additionally to the inner bending tool 23 and the outer bending tool 24, bending tools adjoining these, which have such a cylindrical region, are provided.

FIG. 5 shows a further embodiment variant of the device 21 for radial bending of the conductor element overhangs 11, 12 of the individual conductor elements 3, 4, wherein again, equal reference numbers and/or component designations are used for equal parts as in FIGS. 1 to 4 above. In order to avoid unnecessary repetitions, it is pointed to/reference is made to the detailed description in FIGS. 1 through 4 preceding it.

As can be seen from FIG. 5, it can be provided for that the inner bending tool 23 comprises several inner bending tool segments 35 and that the outer bending tool 24 comprises several outer bending tool segments 36. The inner bending tool segments 35 and/or the outer bending tool segments 36 can be displaced in the radial direction to allow for bending the conductor element overhangs 11, 12 of the individual conductor elements 3, 4. In particular, it can be provided for that a gap is formed between the individual bending tool segments 35 and/or between the individual outer bending tool segments 36, such that the bending tool segments 35, 36 can be displaced in the radial direction 22. Moreover, it can be provided for that the bending tool segments 35 are arranged in a guided manner on the device 21 so as to be displaceable in the radial direction 22 by means of a linear guide.

The inner bending tool segments 35 can be controlled by means of an inner rotary disk 37, which comprises an inner slotted guide 38. By rotating the inner rotary disk 37, the inner bending tool segments 35 can be moved in radial direction 22 via the slotted guide.

Analogously to this, it can be provided for that the outer bending tool segments 36 are displaced by means of an outer rotary disk 39, which comprises an outer slotted guide 40.

FIG. 6 shows a further embodiment variant of the device 21 for bending of the conductor element overhangs 11, 12 of the individual conductor elements 3, 4 in the radial direction 22, wherein again, equal reference numbers and/or component designations are used for equal parts as in FIGS. 1 to 5 above. In order to avoid unnecessary repetitions, it is pointed to/reference is made to the detailed description in FIGS. 1 through 5 preceding it.

In the further embodiment variant, as shown in FIG. 6, the inner slotted guide 38 and the outer slotted guide 40 can be arranged on a common rotary disk 37, 39. In this respect, by rotating the common rotary disk 37, 39, the inner bending tool segments 35 and the outer bending tool segments 36 are fed to one another synchronously.

In particular, it can be provided for that in such a design with a common rotary disk 37 39, the inner slotted guide 38 and the outer slotted guide 40 are designed inversely. Thereby, when the rotary disk 37, 39 is rotated in a first rotational direction, the inner bending tool segments 35 can be moved inwards and the outer bending tool segments 36 can be moved outwards, whereby the bending tool segments 35, 36 are moved apart. When the rotary disk 37, 39 is rotated in a second, opposite, rotational direction, the inner bending tool segments 35 can be moved outwards and the outer bending tool segments 36 can be moved inwards, whereby the bending tool segments 35, 36 are moved towards one another.

Moreover, it can be provided for that the inner bending tool segments 35 and the outer bending tool segments 36 are each accommodated in a bending tool segment guide, in which they are guided to be displaceable in the radial direction 22.

FIG. 8 shows a further exemplary embodiment of the device 21. As can be seen from FIG. 8, it can be provided for that the device 21 is designed such that the first conductor element overhangs 11 of the conductor elements 3, 4 and the second conductor element overhangs 11 of the conductor elements 3, 4, which are arranged on the opposite side of the stator 1, are bent at the same time. For this purpose, it can be provided for that the device 21 comprises two inner bending tools 23 and two outer bending tools 24. In this regard, the inner bending tools 23 and/or the outer bending tools 24 can be formed as already described in the different embodiment variants. Further, the receiving device 25 can be designed as a central clamping jaw by means of which the laminated core 2 can be gripped at its outer lateral surface and thereby rotated. In the alternative to this, the receiving device 25 can also be designed as a clamping roller arrangement acting on the outer lateral surface of the laminated core 2.

FIG. 9 shows a schematic representation of the fanning out operation. As can be seen from FIG. 9, it can be provided for that an inner fanning out tool 41 is provided, which presses the conductor element overhangs 11, 12 of the outer conductor elements 4 radially outwards. Moreover, an outer fanning out tool 42, which serves as a counterhold, can be provided. The inner fanning out tool 41 can be brought into contact with a graduation which is formed due to the different lengths of the conductor element overhangs 11, 12 of the individual conductor elements 3, 4.

The inner fanning out tool 41 and the outer fanning out tool 42 can be designed such that the conductor element overhangs 11, 12 of the individual conductor elements 3, 4 can be bent in the same setting of the laminated core 2, as the radial deformation by means of the inner bending tool 23 and the outer bending tool 24.

Moreover, a spreading tool 43 can be provided which, after fanning out the individual conductor elements 3, 4, can be inserted between the individual conductor elements 3, 4 in the axial direction of the laminated core 2 in order to further form the conductor elements 3, 4.

FIG. 9 shows a schematic representation of the end positioning operation. As can be seen from FIG. 9, it can be provided for that an end positioning tool 44 is formed, which comprises a stepped recess 45. In this regard, the stepped recess 45 can form the contour of the finished bent conductor elements 3, 4. In particular, the individual steps of the stepped recess 45 can be designed such that the individual conductor elements 3, 4 can be brought into contact with it and can thus be brought into their end position in the radial direction 22 and/or in the axial direction by means of the end positioning tool 44.

In particular, it can be provided for that the conductor elements 3, 4 are pre-positioned in pairs by means of the inner fanning out tool 41 and all conductor elements 3, 4 are spaced apart from one another by means of the end positioning tool 44.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

| | |
|---|---|
| 1 | stator |
| 2 | laminated core |
| 3 | inner conductor element |
| 4 | outer conductor element |
| 5 | receiving groove |
| 6 | main axis |
| 7 | first end face |
| 8 | second end face |
| 9 | first conductor element layer |
| 10 | second conductor element layer |
| 11 | first conductor element overhang |
| 12 | second conductor element overhang |
| 13 | laminated core end face region |
| 14 | central region |
| 15 | end region |
| 16 | first circumferential direction |
| 17 | second circumferential direction |
| 18 | insulation layer |
| 19 | length conductor element |
| 20 | length laminated core |
| 21 | device |
| 22 | radial direction |
| 23 | inner bending tool |
| 24 | outer bending tool |
| 25 | receiving device |
| 26 | rolling tool |
| 27 | camber |
| 28 | depression |
| 29 | pressing tool |
| 30 | first turning tool |
| 31 | second turning tool |
| 32 | radius bending |
| 33 | radius conductor element layer |
| 34 | spacer |
| 35 | inner bending tool segments |
| 36 | outer bending tool segments |
| 37 | inner rotary disk |
| 38 | inner slotted guide |
| 39 | outer rotary disk |
| 40 | outer slotted guide |
| 41 | inner fanning out tool |
| 42 | outer fanning out tool |
| 43 | spreading tool |
| 44 | end positioning tool |
| 45 | stepped recess |

1. A method for producing a semi-finished product of a stator or rotor of an electrical machine, wherein the method comprises:
providing an essentially hollow-cylindrical or cylindrical laminated core, wherein the laminated core has a plurality of receiving grooves distributed in a circumferential direction and extending between a first axial end face and a second axial end face of the laminated core;
providing a plurality of rod-shaped or clasp-shaped conductor elements;
inserting the conductor elements into at least some of the receiving grooves, wherein the conductor elements are arranged in receiving grooves spaced apart from one another in different radial conductor element layers, and wherein the conductor elements are inserted into the receiving grooves such that conductor element overhangs of the conductor elements protrude beyond at least one of the axial end faces of the laminated core in the axial direction, wherein the conductor element overhangs extend from a laminated core end face region to a conductor element end region via a conductor element central region;
bending the conductor element overhangs of the conductor elements, in the circumferential direction, wherein the conductor element overhang of conductor elements of a first radial conductor element layer are bent into a first circumferential direction and conductor element overhangs of conductor elements of a second radial conductor element layer are bent into an opposite second circumferential direction, such that the end regions of conductor elements, are joined, the conductor elements arranged in receiving grooves spaced apart from one another and located in conductor element layers adjacent to one another
wherein prior to bending the conductor element overhangs of the conductor elements in the first or second circumferential direction, the conductor element overhangs are bent in a the radial direction.

2. The method according to claim 1, wherein the conductor element overhangs are bent in a bulbous manner in the radial direction, wherein the conductor element overhangs are bent such that at the end of the method for producing a semi-finished product, the end region of the conductor element overhangs is closer to the center of the laminated core than the central region of the conductor element overhangs.

3. The method according to claim 1, wherein the central region of the conductor elements is bent radially outwards.

4. The method according to claim 1, wherein during bending of the conductor element overhangs in the radial direction, a radially inner bending tool presses radially outwards against the central region of the conductor element overhang and a radially outer bending tool presses radially inwards at least against the end region of the conductor element.

5. The method according to claim 4, wherein the inner bending tool and the outer bending tool are designed as rolling tools, which are guided around the circumference of the laminated core at least once in a rolling operation.

6. The method according to claim 5, wherein the inner bending tool and outer bending tool are guided around the circumference of the laminated core multiple times, wherein a feed operation of the inner bending tool and/or of the outer bending tool takes place distributed over multiple revolutions.

7. The method according to claim 4, wherein the inner bending tool and the outer bending tool are formed as a pressing tool segmented in the circumferential direction, which are displaced in the radial direction.

8. The method according to claim 4, wherein the inner bending tool comprises a camber.

9. The method according to claim 8, wherein the outer bending tool comprises a depression corresponding to the camber.

10. The method according to claim 1, wherein a plurality of the conductor elements, which are each arranged in a receiving groove, of different radial conductor element layers are jointly bent in the radial direction, wherein a radially inner bending tool presses against the conductor element overhang of the conductor element arranged in the innermost radial conductor element layer and a radially outer bending tool presses against the conductor element overhang, of the conductor element arranged in the outermost radial conductor element layer.

11. The method according to claim 1, wherein the conductor element overhangs are bent in the radial direction such that they rub against one another as little as possible during bending of the conductor element overhangs in the circumferential direction.

12. The method according to claim 1, wherein the conductor element overhangs are bent in a bulbous manner in the radial direction such that the conductor element overhangs have a radius essentially corresponding to the radius of the respective conductor element layer in which they are arranged.

13. The method according to claim 1, wherein during the bending of the conductor element overhangs in the radial direction, one or more spacers are arranged between the individual conductor elements of different radial conductor element layers.

14. The method according to claim 1, wherein the conductor elements are positioned in the laminated core, such that conductor element overhangs are formed on both the first and the second axial end faces of the laminated core and the conductor element overhangs on both the first and the second axial end faces of the laminated core are bent in the radial direction.

15. The method according to claim 1, wherein the conductor elements are arranged in at least six different conductor element layers.

16. The method according to claim 1, wherein in at least some of the receiving grooves, one conductor element is arranged in each conductor element layer.

17. The method according to claim 1, wherein individual conductor elements or groups of conductor elements are fanned out and spaced apart from one another after bending in the radial direction.

18. The method according to claim 17, wherein the bending of the conductor elements in the circumferential direction and the fanning out of the conductor elements are carried out in one setting.

19. The method according to claim 18, wherein the conductor elements are inserted into the laminated core such that the conductor element overhangs of the conductor elements of the first radial conductor element layer have a lower extension than the conductor element overhangs of the conductor elements of the second radial conductor element layer, wherein a graduation is formed by the conductor elements, wherein, during the fanning out, an inner fanning tool engages on an offset of the graduation and is pressed against the outer conductor element, thereby pressing it outwards.

20. The method according to claim 18, wherein the conductor element overhangs of the conductor elements, after the fanning out, are brought into their end position by an end positioning tool, wherein the end positioning tool comprises a stepped recess corresponding to the conductor element overhangs.

21. The method according to claim 1, wherein after the bending in the circumferential direction, the conductor element overhangs of the conductor elements are bent together in pairs in the radial direction.

22. The method according to claim 1, wherein the conductor element overhangs are bent in the radial direction such that the end region of the conductor element overhangs is aligned in parallel to a main axis.

23. A device for producing a semi-finished product of a stator or rotor of an electrical machine comprising:
a receiving device for receiving a hollow-cylindrical or cylindrical laminated core having conductor elements arranged in receiving grooves of the laminated core, wherein the conductor elements comprise conductor element overhangs, and wherein radially inner bending tool and a radially outer bending tool are formed for bending the conductor element overhangs in a radial direction.

24. The device according to claim 23, wherein the inner bending tool and the outer bending tool are formed as rolling tools.

25. The device according to claim 23, wherein the inner bending tool and the outer bending tool are formed as a pressing tool segmented in the circumferential direction, where segments of the pressing tool are displaceable in the radial direction.

26. The device according to claim 23, wherein the inner bending tool or and/or the outer bending tool comprises an elastic coating on a the contact surface.

27. The device according to claim 23, wherein the inner bending tool and the outer bending tool have a surface parallel to a main axis on an edge region distant from the receiving device.
